(19) United States
(12) Patent Application Publication
(10) Pub. No.: US 2017/0057595 A1
(43) Pub. Date: Mar. 2, 2017

(54) SMART AUXILIARY POWER SYSTEM FOR BICYCLE

(71) Applicant: Sheng Yu Peng, Taoyuan City (TW)

(72) Inventor: Sheng Yu Peng, Taoyuan City (TW)

(21) Appl. No.: 15/213,433

(22) Filed: Jul. 19, 2016

(30) Foreign Application Priority Data
Sep. 1, 2015 (TW) 104128868

(51) Int. Cl. B62M 6/50; G05D 1/00; G01C 21/16; B62M 6/90

(52) U.S. Cl. CPC B62M 6/50; B62M 6/90; G05D 1/0016; G01C 21/16

(57) ABSTRACT

A smart auxiliary power system for bicycles is provided, comprising: an electric motor, an electric auxiliary power device (E-AUX), and an energy storage device; wherein: the electric motor and the E-AUX being mounted on the wheel drum of the bicycle, the energy storage device being electrically connected to the electric motor through the E-AUX; the E-AUX using the kinetic energy information, including acceleration, bicycle position rotational speed and torque of the electric motor to compute with a control algorithm to drive the electric motor through the motor driving, or charging the energy storage device with the electric power generated by the electric motor through energy recycling device. As such, the system can self-adaptively output auxiliary power according to the kinetic energy information of the bicycle-riding to share the pedaling load of the rider while allowing the rider to enjoy the pedaling.

### CROSS-REFERENCE TO RELATED APPLICATION

The present application is based on, and claims priority form, Taiwan Patent Application No. 104128868, filed Sep. 1, 2015, the disclosure of which is hereby incorporated by reference herein in its entirety.

### TECHNICAL FIELD

The technical field generally relates to a smart auxiliary power system for bicycle, and in particular, to a smart adjustment of auxiliary power output based on the kinetic energy of the bicycle.

### BACKGROUND

Bicycles are transportation vehicles powered by human. Bicycle-riding is considered as environmental-friendly, and often used as transportation means to save walking time as well as recreational means to exercise.

An electrical bicycle is disposed with an electrical motor on a bicycle. The electric motor is driven by electricity to propel the bicycle to move. The rider controls the output power through the input unit (such as, such as acceleration grip), and the speed is changed with the output power of the electric motor. Alternatively, the rider can touch a control switch to activate the operation of the electric motor to save the rider from pedaling. However, the pedal-driven spirit in the original bicycle design is lost by such use.

The conventional electric bicycle is designed to monitor the riding state, and then adjust the auxiliary power output according to the riding state. For example, U.S. Pat. No. 8,634,979 disclosed an electric bicycle drive means comprising a power supply storage, a thin electric motor, a tilt angle sensor, a brake actuator sensor, a pedal speed sensor, and a drive control module; the brake actuator sensor is connected to the left and right brake grips, the pedaling speed sensor is connected to the pedal, the tilt angle sensor is mounted to the vehicle body, and the drive control module is electrically connected to each sensor to receive the pedal rotational speed information, the vehicle body tilt angle information, the brake status information, and so on, as a reference to drive the thin electric motor. The shortcomings of the device are as follows:

1.The device focuses on monitoring the riding state as a reference to output power; for example, the brake actuator sensor senses the brake status according to the rider gripping on the brake grip. The pedal speed sensor senses how the rider pedals and translates into rational speed, which is not equal to the riding speed. The tilt angle sensor senses whether the bicycle tilts according to how the rider controls the vehicle body. Finally, the drive control module determines whether to output auxiliary power in accordance with the foregoing sensor information.

2. The shortcoming of this type of monitoring is that it is necessary to install each sensor at different part of the vehicle body, and uses wires to connect to the drive control module. Moreover, the drive control module must be wired to connect to the thin electric motor. Therefore, the entire vehicle body is disposed with many exposed wires, which is not only unsightly, good waterproof structure at the connection joints must also be provided to ensure safety. As such, the cost is increased the cost, and the connection joints are still prone to water seepage, resulting in high failure rate.

### SUMMARY

The primary object of the present invention is to provide a smart auxiliary power system for bicycles, to collaborate with the rider to contribute auxiliary power in a smart manner according to the kinetic energy. Therefore, a bicycle installed with the smart auxiliary power of the present invention must be pedaled by the rider to maintain pedal-driven spirit. During riding, the system, according to the kinetic energy of the bicycle, such as accelerating, rotational speed, rotational torque riding bicycle position, adjust the appropriate auxiliary power output intelligently to propel the bicycle so that the rider can stay pedaling without exhaustion.

To achieve the aforementioned object, the present invention provides a smart auxiliary power system for bicycles, including an electric motor, an electric auxiliary power device (E-AUX), and an energy storage device; the electric motor and the E-AUX being mounted on the wheel drum of the bicycle, the energy storage device being electrically connected to the electric motor through the E-AUX; the E-AUX including an inertial sensor, an energy recycling device, a processor and a motor driving device; the inertial sensor including an accelerometer, a gyroscope and a magnetometer, the processor receiving information of a forward momentum and bicycle position of the bicycle from the inertial sensor and computing rotational speed and rotational torque of the electric motor; according to the obtained information, the processor using a control algorithm to drive the electric motor through the motor driving device, or charging the energy storage device with the electric power generated by the electric motor through energy recycling device.

Because the timing of auxiliary power output in the present invention is based on the reference of forward kinetic energy of the bicycle, this kinetic energy can be obtained through the E-AUX, and the E-AUX can be integrate as a control circuit board for mounting on the wheel drum together with the electric motor, the present invention therefore does not use many exposed wires. Instead, only a set of electrical wires connected to the energy storage device mounted on the bicycle body is used, which requires less waterproof means as well as reduces the failure occurrence.

The kinetic energy referred to in the present invention includes the forward momentum and bicycle position detected by the inertial sensor, the forward momentum including an gravitational acceleration, an rotational angular speed, and so on, the bicycle position including the tilt angle, pitch angle and yaw angle of the bicycle body; and the wheel rotational speed and rotational torque obtained by the processor connected to the electric motor.

Moreover, the E-AUX further includes a wireless transmission device, connected to the processor. In an embodiment, the wireless transmission device is used to communicate information with an external control device. The external control device includes a smart phone. As such, the information of motor temperature, motor output power, bicycle speed, battery energy level, motor rotational speed, and so on can be transmitted to the smart phone to monitor the riding situation. In addition, the smart phone can also be used to input commands, such as, limiting the motor output power, setting bicycle speed, and so on, to ensure riding safety.

Furthermore, the energy storage device of the present invention is a battery, which can be installed on the bicycle exposed. As such, the smart auxiliary power system of the present invention can be mounted to the bicycle, without substantial changes or modifications to the original bicycle structure. In other embodiments, the battery can be hidden inside the body frame of the bicycle, such as in a hollow steel frame. As such, a more lean appearance, better waterproof result, better security to avoid battery theft can all be provided.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a block diagram of the present invention in accordance with a first exemplary embodiment;

FIG. 2 shows a schematic view of the first embodiment of installing the present invention on a bicycle;

FIG. 3 shows a schematic view of the second embodiment of installing the present invention on a bicycle;

FIG. 4 shows a schematic view of a block diagram of the present invention in accordance with another exemplary embodiment; and

FIG. 5 shows a schematic view of the operation of the present invention in different modes.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

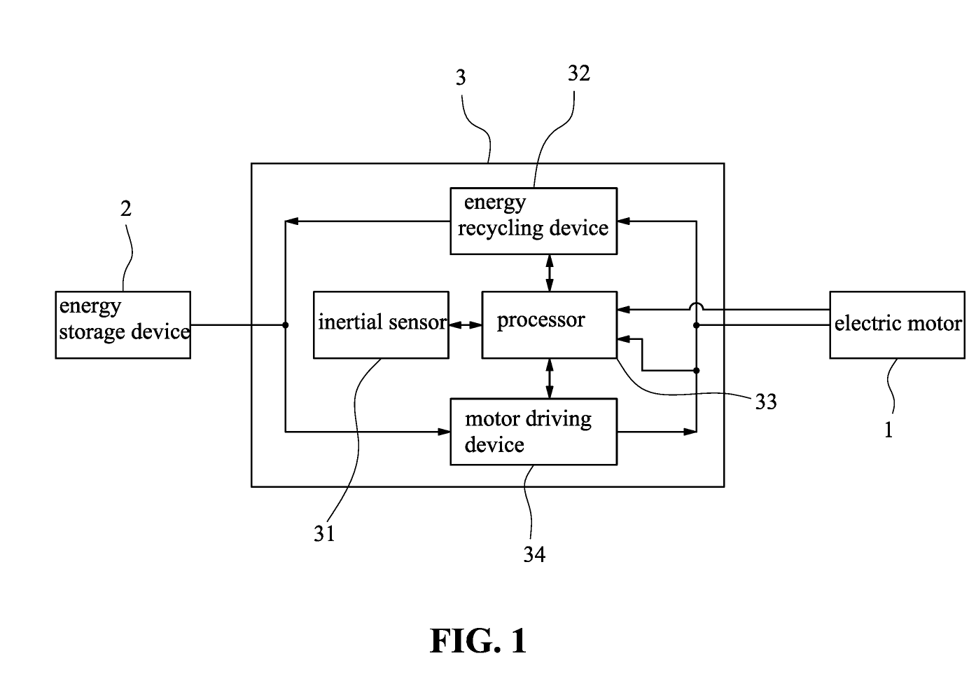

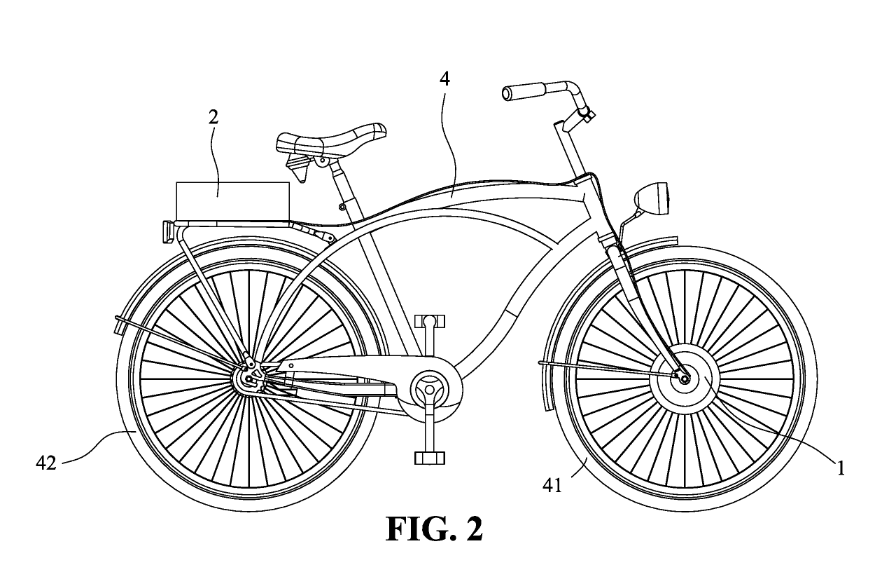

Refer to FIG. 1 and FIG. 2, FIG. FIG. 2 shows a schematic view of the first embodiment of installing the present invention on a bicycle. The smart auxiliary power system of the present invention includes: an electric motor 1, and energy storage device 2, and an electric auxiliary power device (E-AUX) 3.

The electric motor 1 is an electric motor for mounting at a wheel drum. In the present embodiment, the electric motor 1 is mounted on the wheel drum of the front wheel 41 of the bicycle 4. This embodiment can simplify the operation of the vehicle modification and/or installation, of course. The installation can also be on the wheel drum of the rear wheel 42. In addition, the electric motor 1 also has an internal Hall element to output to the motor shaft position to the processor 33 of the E-AUX 3 for the processor 33 to calculate the motor rotational speed, which is also the bicycle speed.

The energy storage device 2 is a battery, and is electrically connected to the electric motor 1 through the E-AUX for using electrically to drive electric motor 1 to rotate, or using and recycling the electricity generated by the electric motor 1 to charge the energy storage device 2.

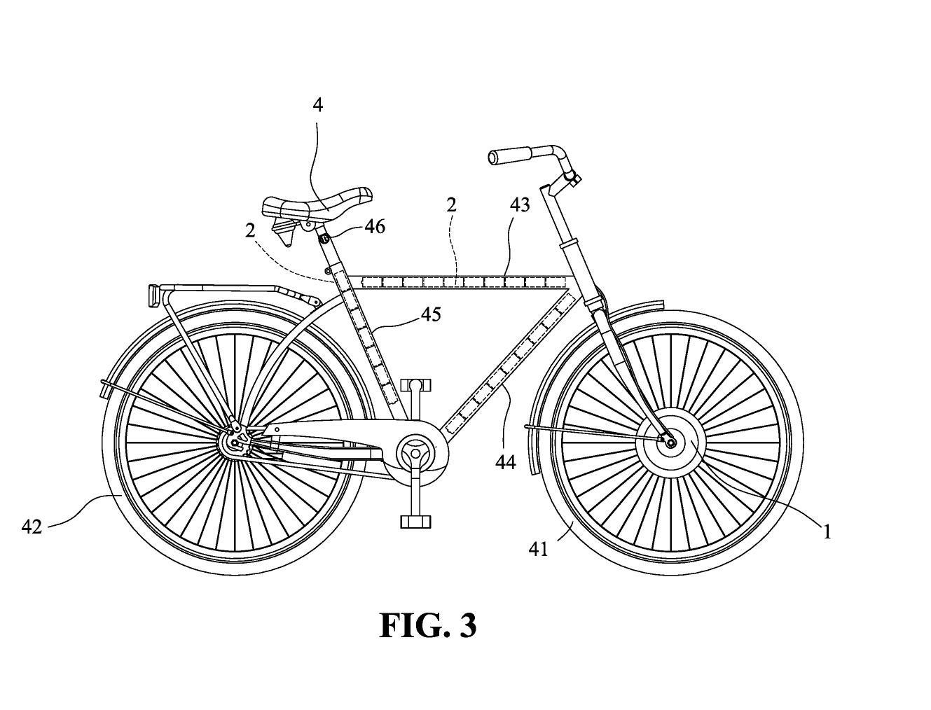

FIG. 3 shows a schematic view of the second embodiment of installing the present invention on a bicycle. In the present embodiment, the energy storage device 2 is hidden in the hollow frame of the bicycle, for example, inside a hollow pipe frame 43, 44, 45, and a concealed recharging connector 46 is disposed underneath the seat. As such, the design enables the shortest exposed wire connecting to the electric motor 1 to improve safety and a tidy appearance, as well as the security from theft and waterproof effect of the energy storage device 2 (i.e., battery).

The E-AUX 3, based on the kinetic energy of the bicycle, including the forward momentum, vehicle position, motor rotational speed and torque information, and so on, uses control algorithm to control intelligently the output current to timely drive the electric motor 1, depending on the road conditions. Also, the electricity of the electric motor 1 can also be recycled to the energy storage device 2. The E-AUX 3 may be an electronic component module, such as, a control circuit board, for being embedded in electric motor 4 at the front wheel 41.

The E-AUX 3 includes an inertial sensor 31, an energy recycling device 32, a processor 33 and a motor driving device 34. The inertial sensor, which is a 3D space sensor, 31 is electrically connected to the processor 33 to obtain the forward momentum and bicycle position, and so on. The inertial sensor 31 includes an accelerometer, a gyroscope and a magnetometer. The accelerometer is to detect the gravitational acceleration of the 3D Cartesian coordinate x, y, z components. The gyroscope is to detect the rotational angular velocity of the 3D Cartesian coordinates x, y, z components. The calculation combining the information from the accelerometer and the gyroscope can obtain the current forward momentum and bicycle position of the bicycle. The forward momentum includes the gravitational acceleration and the rotational angular velocity; and the bicycle position includes the tilt angle, pitch angle and yaw angle of the bicycle body. Because the gyroscope may cause measurement cumulative error of drift angle, the magnetometer is used to eliminate the error for precise measurement.

The processor 33 is also electrically connected to circuit of the motor driving device 34 connected to the electric motor 1 to measure the current on the circuit. After digitization, the current measurement is returned to the processor 33 to calculate the output torque with respect to the electric motor 1. Moreover, as the foregoing, the processor 33 by using the circuit connected to the Hall element inside the electric motor 1 computes the rotational speed of the electric motor. As such, the processor 33, using the forward momentum and bicycle position information obtained by the inertial sensor 31, in combination with the rotational speed and torque information of the electric motor 1 and computation with a control algorithm, can use the motor driving device 34 to output power to drive the electric motor 1 or recycle the electricity to charge the energy storage device 2 self-adaptively according to different conditions.

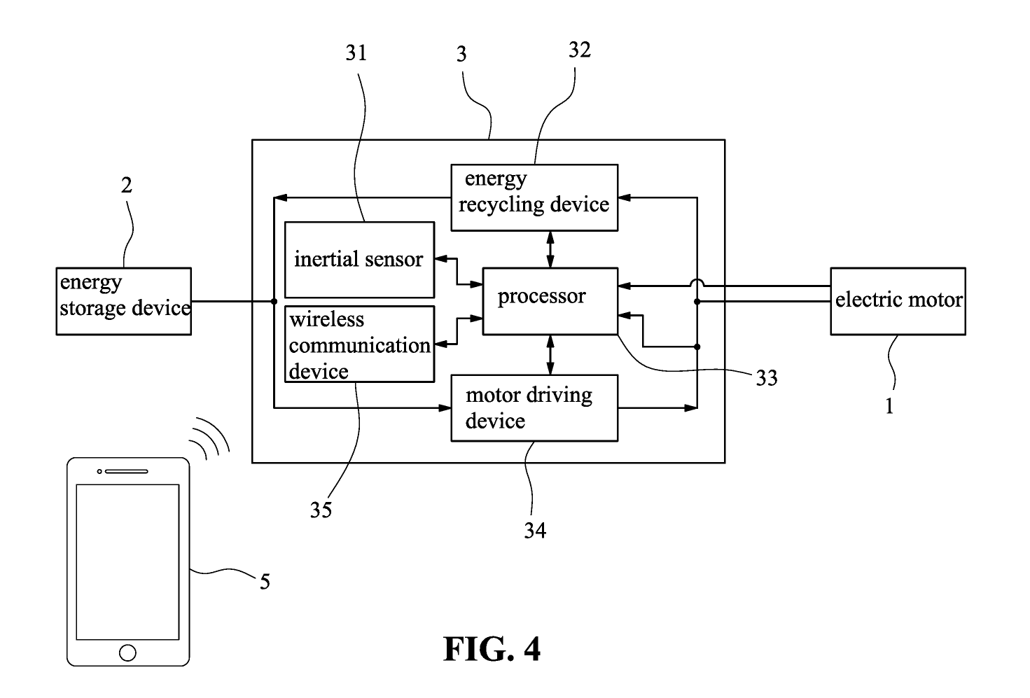

FIG. 4 shows a schematic view of a block diagram of the present invention in accordance with another exemplary embodiment. In the present embodiment, the E-AUX 3 further includes a wireless transmission device 35, connected to the processor 33. The wireless transmission device 35 is used to communicate information with an external control device. In the present embodiment, the external control device is a smart phone 5, but is not restrict to the exemplar. As such, the information of motor temperature, motor output power, bicycle speed, battery energy level, motor rotational speed, and so on can be transmitted to the smart phone 5 by the wireless transmission device 35 to monitor the riding situation. In addition, the smart phone 5 can also be used to input commands, such as, limiting the motor output power, setting bicycle speed, and so on, to ensure riding safety.

The present invention uses the E-AUX 3 to obtain various modes according to the information of forward momentum, bicycle position, rotational speed and torque, and so on during bicycle-riding, and uses the processor 33 with the control algorithm to output power to drive the electric motor 1 or recycle the electricity to charge the energy storage device 2 self-adaptively according to different modes, as follows:

1. Leveled road mode, stable output power: the rider needs pedaling the bicycle so that the auxiliary power will be outputted. The resulted state information is speed gradually increasing, forward momentum gradually increasing, and non-tilt bicycle position.

2. Slow-down mode, slowing or stopping output power: the rider stops pedaling the bicycle bike, and the auxiliary power output will slow down or stop, and finally the bicycle stops. The resulted state information is the rotational torque gradually increasing and the bicycle position unchanged.

3. Climbing mode, increasing power output: the resulted state information is the rotational torque gradually increasing, the forward momentum gradually decreasing, and the bicycle position in an elevation angle state..

4. Downhill mode, the power output stopped or charging battery: the resulted state information is the rotational torque gradually decreasing, the bicycle position in a depression angle state.

5. Cornering mode, decreasing the power output: the resulted state information is the bicycle position in a state of roll angle or yaw angle exceeding a preset threshold.

6. Brake mode, the power output stopped or charging battery: resulted state information is sudden decrease in speed, sudden decrease in forward momentum (for example, a rider brakes), or the rotational speed exceeding a preset value.

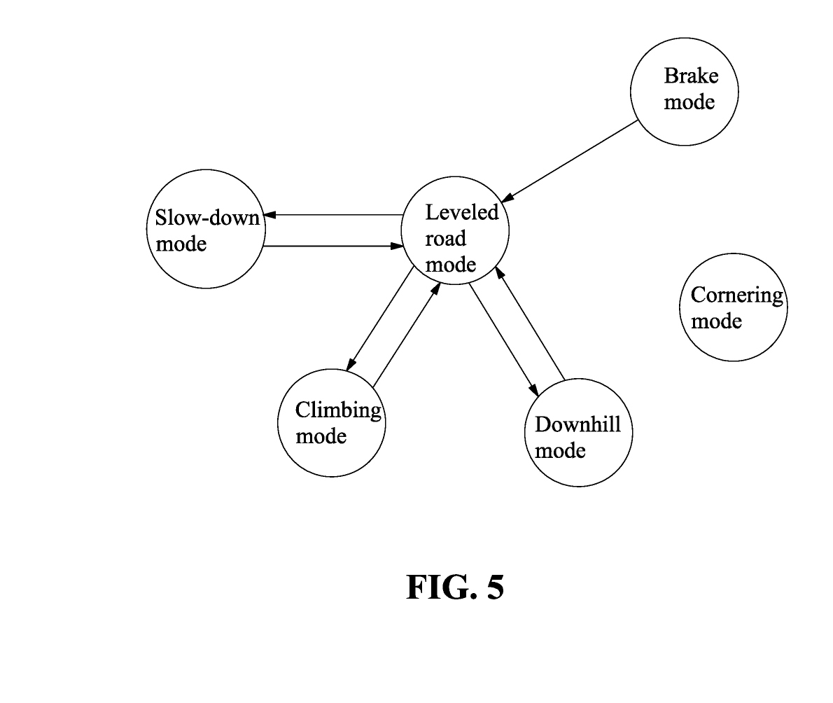

Refer to FIG. 5. The following describes the mode switching and operation in actual riding:

The brake mode is given the highest priority. In this mode, the wheel rotational speed suddenly decreases, and the inertial sensor 31 detects the sudden creases in the forward momentum of the bicycle or the rotational speed of the wheel exceeding a safe threshold, the system enters the brake mode and stops the power output.

When the brake is relieved, if the rider continues to pedal the bicycle, and the rotational speed increases and the inertial sensor 31 detects the speed gradually increasing, forward momentum gradually increasing, and non-tilt bicycle position, the system enters the leveled road mode to output power stably.

When the rider stops pedaling the bicycle, the electric motor gradually increases power consumption to maintain the rotational speed and correspondingly the output rotational torque gradually increases. The inertial sensor detects the bicycle position in an unchanged state, and the system enters the slow-down mode to slow down or stop the power output until the bicycle finally stops. If the rider continues to pedal, the system switches back to the leveled road mode.

When the bicycle travels from a leveled road to a climbing slope, the inertial sensor detects the bicycle position is in a state of elevation angle, and the forward momentum is gradually increasing. To maintain the rotational speed, the motor consume more power and the corresponding output rational torques gradually increases. The system enters the climbing mode to increase the power output to share the workload of the rider.

When the bicycle travels from a climbing slope to a leveled road, the power-consumption of the motor gradually decreases, and the corresponding output rational torques gradually decreases. The inertial sensor detects the bicycle position is changed to a leveled position and the system returns to the leveled road mode.

When the bicycle travels from a leveled road to downhill slope, the inertial sensor detects the bicycle position changes to a state of depression angle, the motor rotational torque continues to decrease and the power-consumption of the motor gradually decreases. The system enters the downhill mode to stop the power output or start recharging the battery.

When the bicycle travels from a downhill slope to a leveled road, the power-consumption of the motor gradually increases, and the corresponding output rational torques gradually increases. The inertial sensor detects the bicycle position is changed to a leveled position. If the rider stops pedaling, the system enters the slow-down mode; if the rider continues to pedal and the rotational speed increases, the system returns to the leveled road mode.

The cornering mode occurs in parallel with the leveled mode, climbing mode and downhill mode. When the inertial sensor detects the bicycle position is in a state of roll angle (the bicycle tilting) or yaw angle (the bicycle turning) exceeding a preset threshold, the system enters the cornering mode and gradually decreases the power output.

In summary, when the smart auxiliary power system of the present invention is installed on a bicycle, the system can self-adaptively output auxiliary power according to the kinetic energy information of the bicycle-riding to share the pedaling load of the rider while allowing the rider to enjoy the pedaling, as well as power recycling when the riding is in the brake or downhill modes.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A smart auxiliary power system for bicycles, comprising: an electric motor, an electric auxiliary power device (E-AUX), and an energy storage device; wherein:
the electric motor and the E-AUX being mounted on the wheel drum of the bicycle, the energy storage device being electrically connected to the electric motor through the E-AUX;
the E-AUX including an inertial sensor, an energy recycling device, a processor and a motor driving device; and
the inertial sensor including an accelerometer, a gyroscope and a magnetometer, the processor receiving information of a forward momentum and bicycle position of the bicycle from the inertial sensor and computing rotational speed and rotational torque of the electric motor; according to the obtained information, the processor using a control algorithm to drive the electric motor through the motor driving device, or charging the energy storage device with the electric power generated by the electric motor through energy recycling device.

2. The smart auxiliary power system for bicycles as claimed in claim 1, wherein the E-AUX further includes a wireless transmission device, connected to the processor.

3. The smart auxiliary power system for bicycles as claimed in claim 2, wherein the wireless transmission device is used to communicate information with an external control device; the external control device comprises a smart phone, and the processor uses the wireless transmission device to transmit the information of motor temperature, motor output power, bicycle speed, battery energy level, motor rotational speed, and so on to the smart phone to monitor the riding situation; the smart phone is used to input commands to the processor adjust the operation of the components of the system.

4. The smart auxiliary power system for bicycles as claimed in claim 1, wherein the forward momentum comprises an gravitational acceleration, an rotational angular speed.

5. The smart auxiliary power system for bicycles as claimed in claim 1, wherein the bicycle position comprises a tilt angle, a pitch angle and a yaw angle of a bicycle body.

6. The smart auxiliary power system for bicycles as claimed in claim 1, wherein the processor is electrically connected to a circuit of the motor driving device connected to the electric motor to measure the current on the circuit; after digitization, the current measurement is returned to the processor for calculating the output torque with respect to the electric motor.

7. The smart auxiliary power system for bicycles as claimed in claim 1, wherein the energy storage device is a battery.

8. The smart auxiliary power system for bicycles as claimed in claim 1, wherein the electric motor is a direct current (DC) drum motor.
